(19) United States
(12) Patent Application Publication
(10) Pub. No.: US 2005/0066455 A1
(43) Pub. Date: Mar. 31, 2005

(54) ROLLING PIG PIPELINE CLEANING APPARATUS

(76) Inventor: Carl Ron Kafka, Calgary (CA)

Correspondence Address: STURM & FIX LLP, 206 SIXTH AVENUE, SUITE 1213, DES MOINES, IA, 50309-4076, US

(21) Appl. No.: 10/671,232

(22) Filed: Sep. 25, 2003

(51) Int. Cl. B08B 9/055

(52) U.S. Cl. 15/3.5

(57) ABSTRACT

A rolling pig pipeline cleaning apparatus (10) including a pig conveyor unit (11) including a base member (20) having a plurality of vertical support columns (21) (21′) etc., each provided with support arms (23) (23′) etc., that support opposed pairs of guide rails (24) (24′) that form a pathway for a plurality of gravity fed pigs (25) to an indexing arrangement (28) that delivers the pigs (25) in a sequential fashion to a pig catching chamber (30) that forms a portion of a high pressure delivery unit (12) that also includes a pig pushing ram (32) for moving a pig (25) from the pig catching chamber (30) into a high pressure chamber (34) wherein, pressurized gas from a pressure generating cylinder (35) forces the pig (25) from the high pressure chamber (34) into a pig feeding tube (33).

### CROSS REFERENCE TO RELATED APPLICATIONS

Not applicable.

### BACKGROUND OF THE INVENTION

1. Field of the Invention

The present invention relates to the field of pipeline cleaning systems in general and in particular to an automated rolling pig conveyor and delivery system for pipelines.

2. Description of Related Art

As can be seen by reference to the following U.S. Pat. Nos. 5,442,826; 5,674,323; 6,085,376; 4,720,884; and 4,016,620, the prior art is replete with both pig constructions per se, as well as, the delivery systems used to inject a pig through a pipeline.

While all of the aforementioned prior art constructions are more than adequate for the basic purpose and function for which they have been specifically designed, they are uniformly deficient with respect to their failure to provide a simple, efficient, and practical rolling conveyor system that feeds a plurality of pigs in a sequential fashion into an automated delivery system that introduces the individual pigs under pressure into a pipeline.

As anyone in a pipeline related industry is all too well aware, routine periodic maintenance of the pipeline requires that a pig be injected under high pressure through the pipeline to remove accumulated material from the interior surfaces of the pipeline. Usually the process requires the manual or automated loading of a single pig into a high pressure injection system over widely spaced time intervals. However, there are other applications that require the sequential loading of pigs over shorter time intervals and it is those specialized applications that this invention is intended to address.

As a consequence of the foregoing situation, there has existed a longstanding need in certain pipeline environments for a new and improved rolling pig pipeline cleaning apparatus that delivers a plurality of pigs in a sequential fashion into a high pressure injection system that forces the individual pigs through a pipeline and the provision of such an apparatus is the stated objective of the present invention.

### BRIEF SUMMARY OF THE INVENTION

Briefly stated, the rolling pig pipeline cleaning apparatus that forms the basis of the present invention comprises in general a pig conveyor unit, a high pressure delivery unit and a control unit.

As will be explained in greater detail further on in the specification, the pig conveyor unit comprises a framework including a base member having a plurality of vertical support columns each equipped with a plurality of support arms that support opposed pairs of guide rails that provide a rolling pathway for a plurality of gravity fed pigs which are delivered to an indexing arrangement that allows the pigs to exit from the guide rails in a sequential fashion.

The high pressure delivery unit comprises a pig catching chamber dimensioned to accept individual pigs wherein, one end of the pig catching chamber is axially aligned with a retractable pig pushing ram that will deliver the individual pigs into a high pressure chamber that is in communication with a pressure generating chamber controlled by an actuator to deliver high pressure gas from the pressure generating chamber into the high pressure chamber for propelling a pig through a pig feeding tube into a pipeline.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is an isolated perspective view of the rolling pig conveyor unit;

FIG. 2 is a front perspective view of the pipeline cleaning apparatus;

FIG. 3 is a schematic diagram of the pig delivery system;

FIG. 4 is an enlarged structural detail view of one of the magnetic limit switches employed in the control unit;

FIG. 5 is an enlarged structural detail view of the pig catcher;

FIG. 6 is an enlarged structural detail view of the high pressure delivery system; and,

FIG. 7 is an enlarged structural detail view of the cylinder separator member.

### DETAILED DESCRIPTION OF THE INVENTION

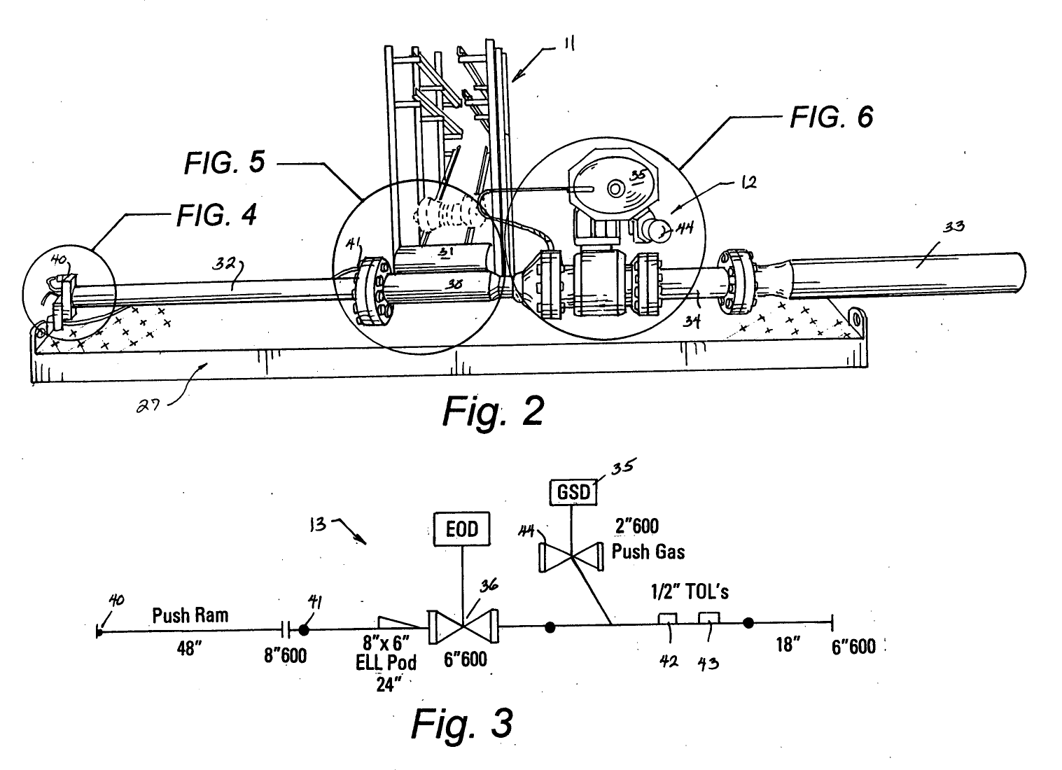

As can be seen by reference to the drawings, and in particular to FIG. 2, the rolling pig pipeline cleaning apparatus that forms the basis of the present invention is designated generally by the reference number 10. The apparatus 10 comprises in general a pig conveyor unit 11, a high pressure delivery unit 12, and a control unit 13. These units will now be described in seriatim fashion.

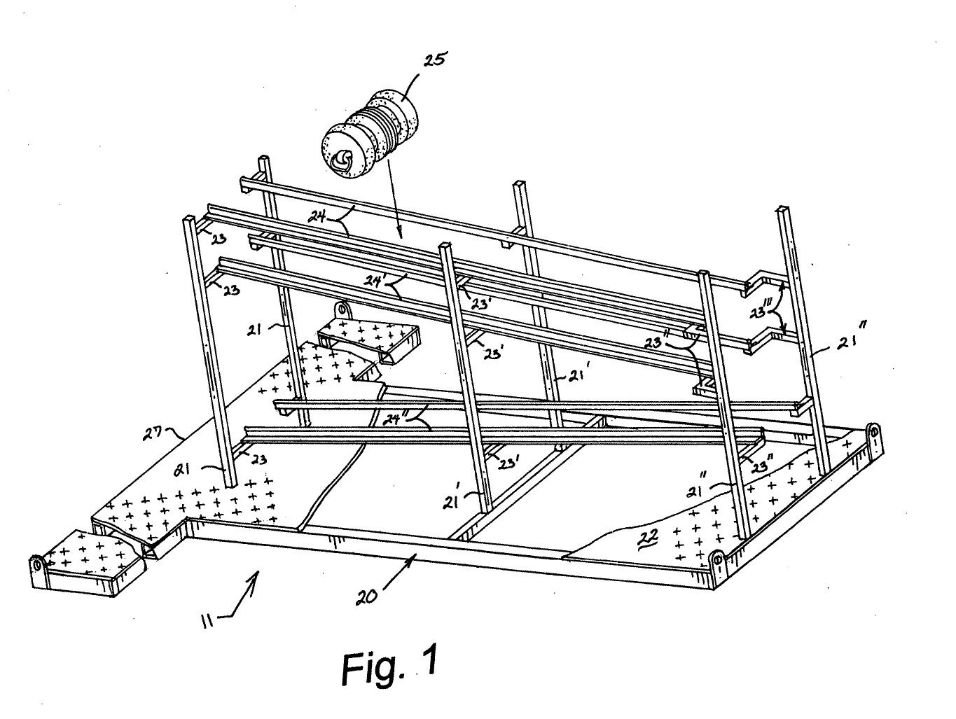

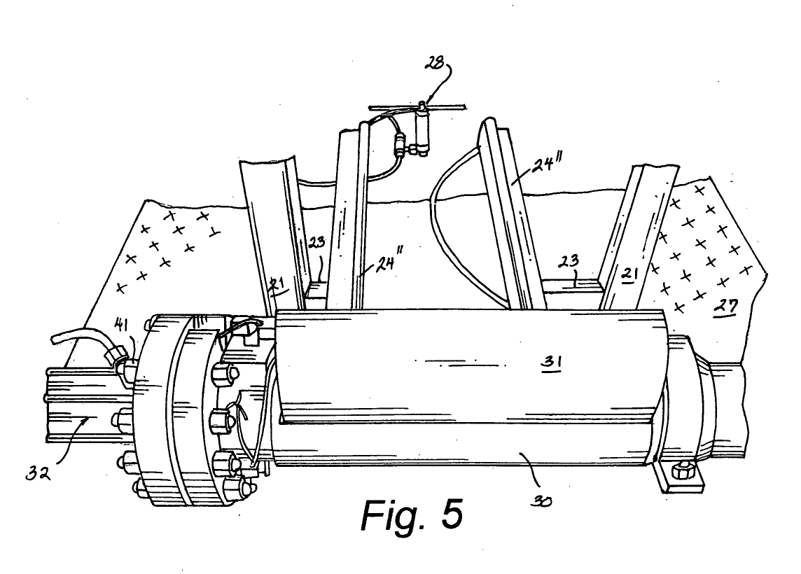

As shown in FIGS. 1, 2, 5, and 7, the pig conveyor unit 11 comprises in general a framework including a generally T-shaped base member 20 that supports a plurality of vertical support columns 21 disposed in spaced pairs along the stem portion 22 of the base member 20 wherein, each of the support columns 21 is provided with three inwardly directed support arms 23 disposed at staggered intervals on the support columns 21 for the purpose of supporting a plurality of elongated guide rails 24.

As can best be appreciated by reference to FIG. 1, the front pair 21 21 and the intermediate pair 21′ 21′ of support columns have generally straight support arms 23 23′ wherein, the rear pair of support columns 21″ 21″ is provided with a lower pair of straight support arms 23″ and two pairs of generally L-shaped support arms 23″ for reasons that will be explained presently.

Still referring to FIG. 1, it can be seen that the front support columns 21 21 have the most widely spaced support arms 23 and the rear support columns 21″ have the most closely spaced support arms 23″ and 23″ which provide support for two pairs of rearwardly inclined upper guide rails 24 and 24′ and a pair of forwardly inclined lower guide rails 24″ that are designed to provide a gravity feed pathway for a plurality of contoured pigs 25.

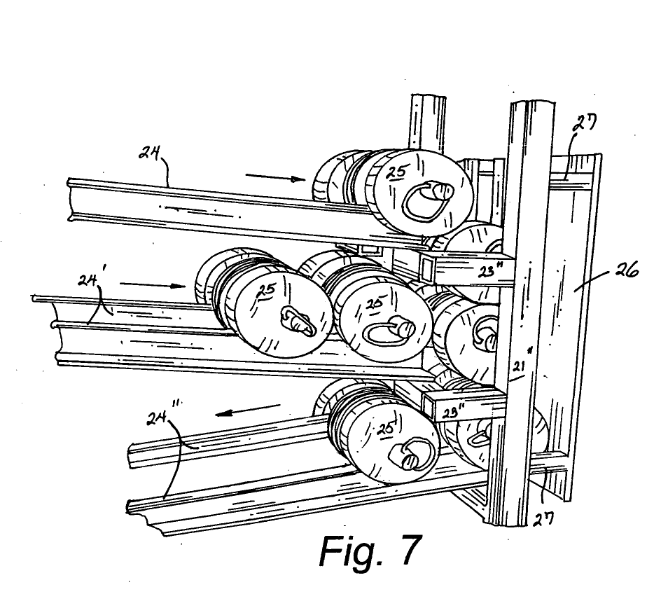

Turning now to FIGS. 1 and 7, it can be seen that the rear support columns 21′ 21″ are further provided with a rearwardly spaced backing plate 26 attached to the rear support columns 21″ 21″ by spacer arms 27 wherein, the L-shaped support arms 23″ and the backing plate 26 define a chute opening that allows the pigs 25 to travel from the upper guide rails 24 24 and 24′ 24′ to the lower guide rails 24″ 24″ in a well recognized fashion to deliver the pigs 25 to the cross-arm portion 27 on the front of the T-shaped base 20.

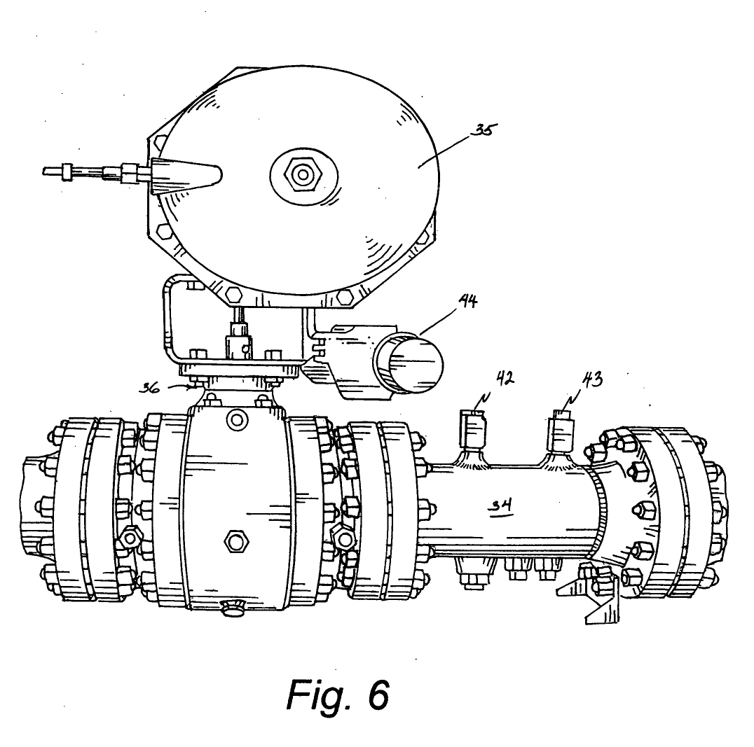

Turning now to FIGS. 2, 5, and 6, it can be seen that the high pressure delivery unit 12 comprises in general a cylindrical pig catching chamber 30 provided with a hinged lid 31 that automatically closes once a pig 25 is released from the front end of the lower guide rails 24″ via an indexing cylinder arrangement 28 that only allows one pig 25 at a time to be fed into the pig catching chamber 30.

As can also be best appreciated by reference to FIG. 2, one end of the pig catching chamber 30 is aligned with and operatively connected to a pig pushing ram 32 and the other end of the pig catching chamber 30 is aligned with a pig delivery tube 33 wherein, a high pressure chamber 34 is disposed intermediate the pig catching chamber 30 and the pig delivery tube 33.

In operation, the pig pushing ram 32 is fully retracted to the position illustrated in FIG. 2 wherein, a magnetic limit switch 40 is triggered to allow the indexing cylinder arrangement 28 to deliver a single pig 25 into the pig catching chamber 30. Then once the pig 25 is received in the chamber 30, the lid 31 is closed and the pushing ram 32 is actuated to drive the pig 25 out of the catching chamber 30 through the high pressure chamber 34 and into the pig delivery tube 33.

The ram 32 must be fully retracted before high pressure gas is introduced into the high pressure chamber 34 via a pressure generation cylinder 35 that is controlled by an actuator 44 that opens a ball valve 36 to introduce high pressure gas into the high pressure chamber 34 to propel the pig 25 through the pig delivery tube 33 and into a pipeline.

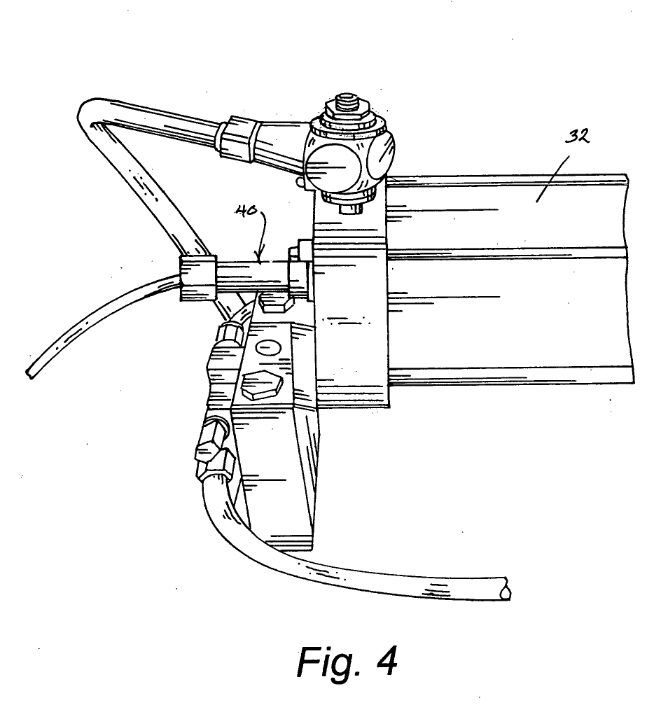

Turning now to FIGS. 3 through 6, it can be seen that the control unit 13 comprises in general a pair of magnetic limit switches 40 41 that controls the extension and retraction of the pushing ram 32, a pair of sensors 42 43 that purges the high pressure chamber with nitrogen gas and an actuator 44 that responds to the sensors 42 43 to open the ball valve 36 to allow pressurized gas from the pressure generation cylinder 35 to enter into the high pressure chamber 35 to propel the pig 25 through a pipeline (not shown) in a well recognized manner.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. A rolling pig pipeline cleaning apparatus for propelling a plurality of individual pigs in a sequential fashion through a pipeline wherein, the apparatus comprises:
a cylindrical pig catching chamber having a pig pushing ram axially aligned with a first end of the pig catching chamber and a high pressure chamber axially aligned with a second end of the pig catching chamber wherein, at least a portion of the pig pushing ram is dimensioned to extend through the pig catching chamber to transport a pig from the pig catching chamber into the high pressure chamber
a pig conveyor unit including opposed pairs of support columns having a plurality of support arms that support at least one rearwardly angled upper pair of guide rails and one forwardly angled lower pair of guide rails wherein, each of said pairs of guide rails forms a rolling pathway for a plurality of individual pigs
first means for sequentially introducing an individual pig into said pig catching chamber; and,
second means for introducing high pressure gas into said high pressure chamber.

2. The apparatus as in claim 1; wherein, said lower pair of forwardly angled guide rails has a lower end which terminates adjacent to said pig catching chamber.

3. The apparatus as in claim 2; wherein, said first means comprises an indexing cylinder arrangement that feeds one individual pig at a time into the pig catching chamber.

4. The apparatus as in claim 4; wherein, said second means comprises at least in part a pressure generating cylinder operatively associated with said high pressure chamber and an actuator associated with the pressure generating cylinder for releasing high pressure gas into said high pressure chamber.

5. The apparatus as in claim 4; wherein, said second means further comprises a valve disposed intermediate the pressure generating cylinder and the high pressure chamber.

6. The apparatus as in claim 1; wherein, the extension and retraction of the pig pushing ram is governed by a pair of spaced limit switches.

7. The apparatus as in claim 4; wherein, the extension and retraction of the pig pushing ram is governed by a pair of spaced limit switches.

8. The apparatus as in claim 1; wherein, said high pressure chamber is provided with at least one purge sensor.

9. The apparatus as in claim 5; wherein, said high pressure chamber is provided with at least one purge sensor.

10. The apparatus as in claim 6; wherein, said high pressure chamber is provided with at least one purge sensor.

11. The apparatus as in claim 7; wherein, said high pressure chamber is provided with at least one purge sensor.
